(19) United States
(12) Patent Application Publication
(10) Pub. No.: US 2005/0076336 A1
(43) Pub. Date: Apr. 7, 2005

(54) Method and apparatus for scheduling resources on a switched underlay network

(75) Inventors: William Doug Cutrell, San Francisco, CA (US); Howard J. Cohen, Palo Alto, CA (US); Tal Lavian, Sunnyvale, CA (US)

Correspondence Address: JOHN C. GORECKI, ESQ., 180 HEMLOCK HILL ROAD, CARLISLE, MA, 01741, US

(73) Assignee: Nortel Networks Limited, St. Laurent (CA)

(21) Appl. No.: 10/719,225

(22) Filed: Nov. 21, 2003

Related U.S. Application Data
(60) Provisional application No. 60/508,524, filed on Oct. 3, 2003.

(51) Int. Cl. G06F 9/46

(52) U.S. Cl. 718/100

(57) ABSTRACT

A method and apparatus for resource scheduling on a switched underlay network enables coordination, scheduling, and scheduling optimization to take place taking into account the availability of the data and the network resources comprising the switched underlay network. Requested transfers may be fulfilled by assessing the requested transfer parameters, the availability of the network resources required to fulfill the request, the availability of the data to be transferred, the availability of sufficient storage resources to receive the data, and other potentially conflicting requested transfers. In one embodiment, the requests are under-constrained to enable transfer scheduling optimization to occur. The under-constrained nature of the requests enables requests to be scheduled taking into account factors such as transfer priority, transfer duration, the amount of time it has been since the transfer request was submitted, and many other factors.

### CROSS REFERENCE TO RELATED APPLICATIONS

This application is a continuation in part of prior Provisional U.S. Patent Application No. 60/508,524, filed Oct. 3, 2003, the content of which is hereby incorporated herein by reference.

### BACKGROUND

1. Field

This application relates to communication networks and, more particularly, to a method and apparatus for scheduling resources on a switched underlay network.

2. Description of the Related Art

Data communication networks may include various computers, servers, nodes, routers, switches, hubs, proxies, and other devices coupled to and configured to pass data to one another. These devices will be referred to herein as “network devices,” and may provide a variety of network resources such as communication links and bandwidths. Conventionally, data has been communicated through the data communication networks by passing protocol data units (or cells, frames, or segments) between the network devices by utilizing one or more type of network resources. A particular protocol data unit may be handled by multiple network devices and cross multiple communication links as it travels between its source and its destination over the network.

Grid networks is an emerging application that builds overlay networks, i.e. computational Grids, on existing network infrastructures using Grid computing technology. In a Grid network, which forms a virtual organization, Grid nodes are distributed widely and share computational resources such as disk storage, storage servers, shared memory, computer clusters, data mining, and visualization centers, although other resources may be available as well. One example of Grids is the TeraGrid, in which Grid computing technology has been deployed to enable supercomputer clusters distributed in four distant locations in the United States to collaboratively work on computationally intense tasks, such as high-energy physics simulations and long-term global weather forecasting. Other potential uses for Grid computing include genomics, protein structure research, computational fluid dynamics, astronomy and astrophysics, Search for ExtraTerrestrial Intelligence (SETI), computational chemistry, “intelligent” drug design, electronic design automation, nuclear physics, and high-energy physics. Grid computing may be used for many other purposes as well, and this list is not intended to be inclusive of all possible uses.

Some of these applications are or are expected to be capable of producing an incredible amount of data that must be distributed to other Grid applications for analysis. For example, high energy physics experiments expected to begin in 2007 are expected to produce data at a rate that may exceed one petabyte of data per year (1 petabyte=1000 Terabyte=10¹⁵ bytes). This data must be sent to many different sites, such as research facilities and universities around the world, for analysis and storage.

When faced with data volumes this large, traditional packet switched networks, such as TCP/IP based communication networks, tend to become overloaded and incapable or inefficient at handling these large data transfers. One technology that is capable of handling these large data transfers is the use of switched optical networking. Typically, each transfer, which is typically several hundred gigabytes to several terabytes in size, uses a dedicated switched optical link. These links are typically provisioned to operate at 10 gigabits/second over each dedicated wavelength (lambda), and multiple lambdas can be multiplexed together to provide bandwidth sufficient to transfer these vast quantities of data.

Conventional optical network reservation is done based on current availability and on-demand scheduling and reservation. This reservation scheme takes into account only the network aspects, such as availability of the network resources, without considering other aspects of the data transfer, such as the availability of the data services that will be required to participate in the data transfer. Additionally, conflicts involving multiple resources and multiple requests cannot be handled by existing reservation schemes. Rather, requests are currently either satisfied or not, and no facility exists to optimize scheduling. Accordingly, a need exists to provide enhanced scheduling for large volume data transfers over switched underlay networks.

### SUMMARY OF THE DISCLOSURE

In the following detailed description, a method and apparatus for scheduling resources on a switched underlay network is described. One embodiment of the invention enables coordination, scheduling, and scheduling optimization to take place taking into account the availability of the data and the network resources comprising the switched underlay network. In this embodiment, requested transfers are fulfilled by assessing the requested transfer parameters, the availability of the network resources required to fulfill the request, the availability of the data to be transferred, the availability of sufficient storage resources to receive the data, and other potentially conflicting requested transfers. In one embodiment, the requests are under-constrained to enable transfer scheduling optimization to occur. The under-constrained nature of the requests enables requests to be scheduled taking into account factors such as transfer priority, transfer duration, the amount of time it has been since the transfer request was submitted, and many other factors.

### BRIEF DESCRIPTION OF THE DRAWINGS

Aspects of the present invention are pointed out with particularity in the claims. The following drawings disclose one or more embodiments for purposes of illustration only and are not intended to limit the scope of the invention. In the following drawings, like references indicate similar elements. For purposes of clarity, not every element may be labeled in every figure. In the figures:

FIG. 1 is a functional block diagram of an example of a communication network including a data transfer scheduling service according to an embodiment of the invention;

FIG. 2 is a functional block diagram of a data transfer scheduling service network architecture according to an embodiment of the invention;

FIG. 3 is a functional block diagram of the data transfer scheduling service network architecture of FIG. 2 in greater detail according to an embodiment of the invention;

FIG. 4 is a flow diagram illustrating a process of scheduling resources on the network architecture of FIGS. 2 and 3 according to an embodiment of the invention;

FIG. 5 is a functional block diagram of a data management service configured to implement an embodiment of the invention; and

FIG. 6 is a functional block diagram of a network resources manager configured to implement an embodiment of the invention

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

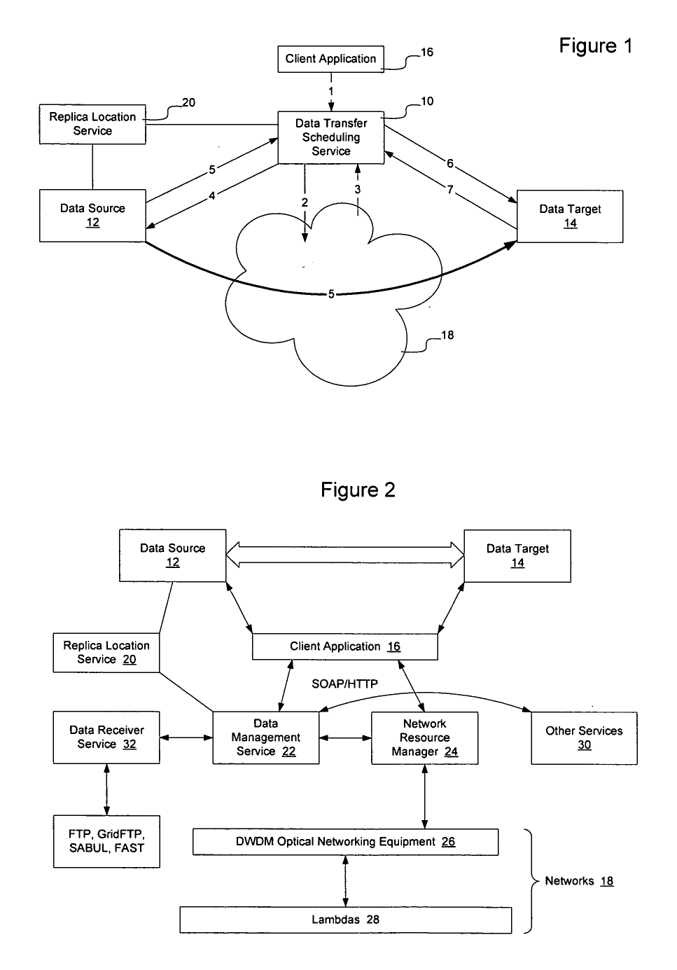

FIG. 1 illustrates an example communication network architecture according to an embodiment of the invention in which a data transfer scheduling service 10 is configured to schedule transfers of data between a data source 12 and a data target 14. The data source and data target may be associated with ftp server daemons configured to send and receive data on demand. In this embodiment, a client application 16 is configured to request the transfer of data from the data source 12 to the data target 14 and need not be associated with either the source or the target. Scheduling of the request is performed by the data transfer scheduling service 10 operating as described in greater detail below.

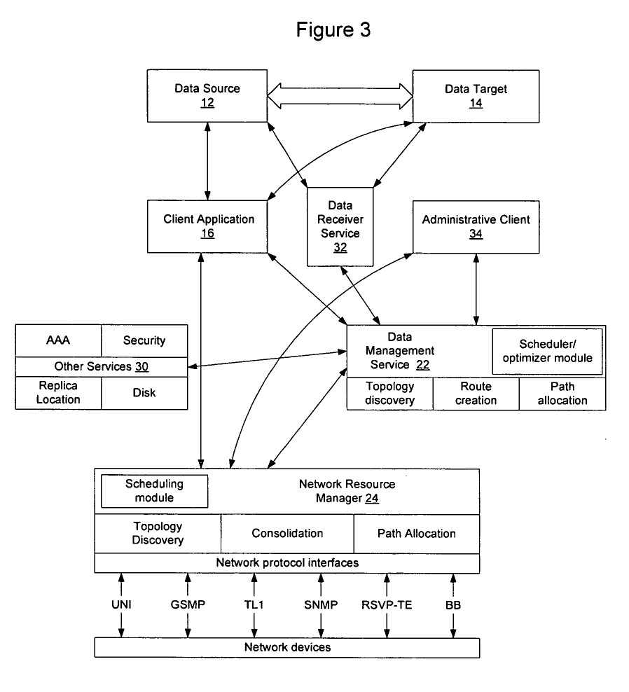

As shown in FIG. 1, an application seeking to effectuate the transfer of data from a data source 12 to a data target 14 interfaces a data transfer client application which issues a request to a data transfer scheduling service (arrow 1). The data transfer scheduling service reserves resources on the network to facilitate the data transfer (arrows 2 and 3) and coordinates with the data source (arrows 4 and 5) and data target (arrows 6 and 7) to ascertain the availability of the data at the data source, and the capacity to receive the data at the data target. The data transfer scheduling service may coordinate with the network resources, data source, and data target in any desired order and the invention is not limited to interfacing with these components in any particular order. As discussed in greater detail below in connection with FIGS. 2 and 3, the data transfer scheduling service may include several logical sub-components, although the invention is not limited to the particular implementations described herein but rather extends to any manner of performing the scheduling associated with the data transfer scheduling service.

According to one embodiment, the data transfer scheduling service is a system for scheduling and controlling high bandwidth wavelength-switched optical network connectivity to fulfill data transfer requests. As described in greater detail below, the data transfer scheduling service is a scheduled management system for application-level allocation in a switched network, which is an underlay for a packet network. In this embodiment, the system is configured to receive requests for switched network allocations with requested scheduling constraints, and responds with scheduled reservations for the switched network resources. The data transfer scheduling services may also manage the data transfer and optionally provide data storage in connection with the data transfer. According to one embodiment of the invention, the data transfer scheduling server may allow data transfers to occur:

on demand (right now);

rigidly in the future (e.g., “tomorrow precisely at 3:30 am”);

loosely in the future (e.g., “Tuesday, after 4pm but before 6pm”); and

constrained by events (e.g., “after event A starts or event B terminates”);

although many other types of reservations may be made as well, and the invention is not limited to a system that is able to implement these or only these particular types of network resource reservations. A reservation request that is not rigidly fixed with precise required parameters will be referred to herein as under-constrained. In this context, an under-constrained resource reservation request enables the request to be fulfilled in two or more ways rather than only in one precise manner.

The data transfer scheduling service enables network resource optimization to be performed taking into account the constraints set forth in the received requests. This may involve a callback system, where previously reserved network allocations are undone and rerouted and/or rescheduled in order to satisfy additional requests or higher priority requests received after the initial scheduling is completed. In this embodiment, the system calls back to the requesting client and asks it to reschedule a reservation. The client then agrees, by calling the system with a new request, relinquishing its existing reservation, or it may choose not to do so.

The scheduling module also includes hardware and software configured to enable it to query the network for its topology and the relevant characteristics of each segment. It includes one or more routing modules to plan available and appropriate paths between requested endpoints in (or near) requested time windows; and the ability to allocate specific segment-by-segment paths between endpoints, and to relinquish them when the data transfer is done or when the user decides to cancel a reservation or request.

The data transfer scheduling service also provides a higher-level service that manages data transfers using the bandwidth allocated by the lower-level service described above. This data transfer service uses the reserved and scheduled network allocations to effect file transfers as specified by the clients' requests. The data transfer service has all the same scheduling characteristics as described above, and can do aggressive optimizations involving rescheduling within the boundaries of the previously requested reservation constraints. These transfers may use an underlying file transfer mechanism to complete the transfer using the reserved and allocated optical network. Several available transfer mechanisms include:

File Transfer Protocol (FTP);

GRIDftp;

Fast Active Queue Management Scaleable TCP (FAST);

TSUNAMI (a protocol that uses TCP for transferring control information and UDP for data transfer);

Simple Available Bandwidth Utilization Library (SABUL)—a UDP-based data transfer protocol;

Blast UDP;

Striped SABUL (P-SABUL); and

Psockets.

Other transfer mechanisms may be used as well and the invention is not limited to an implementation that uses one of these several identified protocols.

The client application can request a transfer of a named data set between two computers, neither of which are associated with the client application. The data source machine needs only to be running a server which can interact with the data transfer protocol used by the data target, e.g., ftp. The receiving machine needs to have a data receiver service daemon running to enable it to receive the data transfer.

Additionally, the requesting client may not know where the data source actually resides on the network, or there may be replicas of the data that reside in a number of places on the network. The data transfer scheduling service may interact with a replica location service 20 to find the location(s) on the network of the actual files that make up the named data set. Then, the data transfer scheduling service may choose a convenient source location based on a number of factors, such as the physical proximity of the data source to the data target, the availability of the data source to fulfill the request, the cost associated with obtaining the data from the data source, and many other factors. Optionally, after the data set has been moved, the replica location service may be notified that another copy of the data exists, and its location. One replica location service is currently being developed in connection with the GRID initiative.

The data transfer scheduling service can be instantiated in many forms on the network, such as a stand-alone Web Service, or as a Web Service configured to interact with other Web Services. For example, the data transfer scheduling service may interact with other Web Services, such as those which manage disk storage and those which manage computational resource availability, in order to coordinate all of these disparate resources to fulfill a submitted transfer request. In one embodiment, the data transfer scheduling service is instantiated using the Globus Toolkit, such that components are configured with Open Grid Services Interface (OGSI) compliant application interfaces within the Open Grid Services Architecture (OGSA).

Embodiments of the invention may provide one or more features, such as the ability to optimize network utilization, the ability to reschedule resource allocation, the ability to coordinate with client-side applications, and the ability to notify client-side applications of allocated resources or the need to reallocate resources. Additional or alternative features may be included as well and the invention is not limited to an embodiment providing this specific selection of features.

In this embodiment, the data transfer scheduling service may include the ability to optimize fulfillment of requests and optimize network utilization based on the constraints contained within the requests. This embodiment provides a framework that can be used to support other services, such as priority models, accounting services, and other embellishments. It may include a mechanism, such as an ability to interface a replica location service, for querying to find the most appropriate source for a requested data set when multiple mirror or replica copies are available.

The data transfer scheduling service may also be configured to provide a rescheduling facility. That is, it may be configured to receive requests to reschedule previously scheduled reservations, and respond with new scheduled reservations, which may or may not implement the requested rescheduling (the “new reservation” may be identical to the old one).

The data transfer scheduling service may also be configured to provide a notification facility. That is, a reservation request may include a client-listener provided for notification callbacks. The data transfer scheduling service, in this embodiment of the invention, may be configured to issue notifications of changes in the status of the scheduled reservation to be received by the client-listener.

The data transfer scheduling service may also be configured to provide facilities for client-side cooperative optimization. That is, a facility may be provided to send requests to the client-listeners for client-initiated rescheduling. In this embodiment, new reservation requests may be satisfied with the cooperation of another client, so that existing reservations may be rescheduled to accommodate new requests. Accordingly, cooperative rescheduling of previously granted reservations may be performed in order to accommodate reservation requests that cannot be otherwise satisfied, or to accommodate new higher priority requests.

Another aspect of the data transfer scheduling service according to embodiments of the invention is a system for scheduled management of data transfers, with coordination of multiple resources such as storage, network, and computation. This aspect may be a client to the network management system configured to schedule network resources described above or may be an independent network service. According to one embodiment of the invention, the management aspect of the data transfer scheduling service interacts with other resource managers as needed to coordinate other codependent resources such as storage and computation. The data transfer management system receives requests with scheduling constraints which may be under-specified, and optimizes usage of network and storage resources globally, using the freedom afforded in the under-specification of the client requests to reschedule as needed. That is, the data transfer system reschedules activity while continuing to satisfy previous requests, using flexibility in the requested scheduling constraints to provide optimized resource utilization in the face of changing demands.

FIG. 2 illustrates an architecture that may be used to implement an embodiment of the invention. As shown in FIG. 2, in this embodiment, client applications 16 interact with a data management service 22 and a network resource manager 24 to effect transfers of data between a data source 12 and a data target 14 over an underlay network 18. Interactions between the client and the data transfer scheduling service 10 may take place using a communication protocol such as Simple Object Access Protocol (SOAP), Extensible Markup Language (XML) messaging, Hyper Text Transfer Protocol (HTTP), Data Web Transfer Protocol (DWTP) or another conventional protocol.

The underlay networks are generally provided by Dense Wavelength Division Multiplexing (DWDM) optical networking equipment 16 that provides optical transmission capabilities over wavelengths (lambdas) 28 on optical fibers running through the network. The optical fiber network may also be used to carry packetized traffic when not reserved for data transmissions by the data transfer scheduling service. The underlay networks according to one embodiment are considered switched underlay networks because the reservations to be effected on these underlay networks for data transfer involve reservation of one or more lambdas on the network for a particular period of time. The underlay network hence appears as a switched network resource, rather than a shared network resource, since the network resource has been reserved for a particular transfer rather than being configured to handle all general packet traffic, as is common in a conventional shared network architecture.

As discussed in greater detail below, the network resource manager provides scheduled management of raw network resources (i.e. lambda allocations scheduled for the future). This application service is concerned only with network resources—not data management. The data management service provides scheduled management of data transfer jobs. It makes direct use of the network resource manager, but also interacts with the replica locator service, data source and data receiver involved in the data transfer. To achieve optimal performance, this data management service is tightly coupled to the network resource manager, although the network resource manager can be used by applications independently of the data transfer service.

In the architecture of FIG. 2, the network resource manager 24 is configured to interface multiple physical/logical network types interacting via multiple network interface and management protocols. The network resource manager performs topology discovery on the network to discover how the underlay network elements are configured and what resources are deployed throughout the network.

Network information received by the network resource manager is consolidated for presentation to the data management service 22. By consolidation, in this instance, is meant that the network resource manager consolidates all information from the underlay networks and presents a single uniform view of them to the upper layers, (either the data management service or a directly accessing application). That is, the network resource manager abstracts the actual networks it is managing so that the upper layers do not need to be concerned with details not relevant to their models. For example, in topology discovery, a network of abstract nodes and links is returned by the network resource manager to its caller in response to a request for topology discovery. In this return, each node and link has a set of properties that may be relevant to doing routing for path allocation, etc. But those details not needed for these tasks may be hidden. Accordingly, the consolidation function serves to eliminate information that will not be pertinent to other modules when performing their assigned tasks.

The network resource manager 24 also performs path allocation. Specifically, the network resource manager, in connection with topology discovery, may allocate paths through the network that will be used to effect transfers of data. The path allocation module, in addition to allocating paths, also effects reservations on the allocated paths so that the data receiver service (discussed below) can use the paths to effect the transfer of data between the data source and data target.

The network resource manager also includes the ability to perform scheduling and optimization of network resources. Unlike the data management service, the network resource manager performs scheduling on the network resources without consideration of the availability of the source and destination of the data. Network resources scheduled by the network resource manager are communicated to the data management service. Additionally, conflicts in reservations or the inability to fulfill a reservation is transferred to the data management service for scheduling optimization as discussed in greater detail below. By enabling the network resource manager to perform path allocation and scheduling, as well as network discovery, it is possible to enable the network resource manager to reserve resources directly on behalf of the client applications 16 in addition to through the cooperative interaction between the network resource manager and the data management service 22.

The data management service 22 supports topology discovery, route creation, path allocation, interactions with the replica location service 20 and data transfer scheduling. The topology discovery function of the data management service receives abstracted network configuration information from the consolidation module in the network resource manager to have a high level view of the network that will be used to effectuate the data transfer. Interactions with the replica location service enable the data management service to locate an available source of the target data set. The data management service may use this information to perform path allocation and make routing decisions as to how the data transfer is to take place on the network. These path allocations and routing decisions will be passed to the network resource manager in connection with a scheduled transfer and used by the network resource manager to reserve resources on the underlay networks.

The data management service also includes a scheduler/optimizer that is configured to perform transfer scheduling and optimization as discussed above to schedule constrained and under-constrained data transfers requested by clients 16.

The data management service 22 interacts with one or more other services modules 30 on the network to enable it to have access to advanced functions not directly configured in the data management services 22 or the network resources manager 24. Examples of other services that may be available include the data replica location service, a disk/storage service, Authentication Authorization and Accounting (AAA) services, security services, and numerous other services.

For example, a data replica location service may be used to locate a source of data or to discern between available sources of data to select an optimal source of data as discussed above. An AAA service may be provided to enable the applications to be authenticated on the network, enable the network components such as the data management service and the network resource manager to ascertain whether the application is authorized to perform transactions on the network, and to allow accounting entries to be established and associated with the proposed transaction. Additionally, a security service may be interfaced to provide security in connection with the request or data transfer to enable the transaction to occur in a secure fashion and to enable the data to be protected during the transfer. For example, the security module may support the creation of Virtual Private Network (VPN) tunnels between the various components involved in securing the transfer of data across the network. Numerous other services may be performed as well and the invention is not limited to an architecture having only these expounded services.

Once a transfer has been scheduled and the bandwidth reserved on the network, the data receiver service effects the transfer between the applications. The transfer may use FTP, GRID FTP, SABUL, TSUNAMI, FAST, one of the transfer mechanisms mentioned above, or another convenient file transfer protocol. The data receiver service assists in the transfer of the data by checking to see if the source file exists, reporting on parameters associated with the source file such as its size and permissions, optionally checking with the data target to see if there is enough disk space to hold the transfer, causing the transfer to happen, reporting back on the status of the transfer when queried, and informing the data management service that a transfer has been completed or if there is a problem with the transfer. Other functions may be performed as well and this list of functions is intended merely as an example of some of the functions that may be performed by the data receiver service. According to one embodiment of the invention, to make the components compatible with GRID computing technology, all application layer interfaces are configured to be OGSI compatible. This enables the network resource manager, data management service, other services, and data receiver services, to be treated as resources in a GRID computing environment so that they may be accessed by the applications either through GRID resource manager or directly in much the same way as an application would access other GRID resources.

FIG. 3 illustrates the network architecture of FIG. 2 in greater detail. As shown in FIG. 3, a client application 40 may send a request for data transfer between a data source 12 and a data target 14 to either the data management service 22 or the network resource manager 24. The network resource manager and the data management service interoperate and have modules configured to perform any required network topology discovery, consolidation, route creation, path allocation, and scheduling, to ascertain availability of network resources and effect reservation of those network resources. Where network reservations are altered, due to scheduling conflicts, the network resource manager and data management service may also interoperate to effect a release of the reservation of the network resources.

In connection with this, the network resource manager may be required to interface with many different types of network resources and may need to communicate with the networks and network devices using a number of protocols. In FIG. 3, the network resource manager is illustrated as being configured to communicate with network devices using the following protocols:

User to Network Interface (UNI), a protocol developed to interface Customer Premises Equipment (CPE) such as ATM switches and optical cross connects with public network equipment;

General Switch Management Protocol (GSMP), a general Internet Engineering Task Force (IETF) protocol configured to control network switches;

Transaction Language 1 (TL1), a telecommunications management protocol used extensively to manage SONET and optical network devices;

Simple Network Management Protocol (SNMP), an EETF network monitoring and control protocol used extensively to monitor and adjust Management Information Base (MIB) values on network devices such as routers and switches;

Resource Reservation Protocol—Traffic Engineering (RSVP-TE), a signaling protocol used in Multi-Protocol Label Switching (MPLS) networks, that allows routers on the MPLS network to request specific quality of service from the network for particular flows, as provisioned by a network operator; and

Bandwidth Broker, an Internet2 bandwidth signaling protocol.

Other conventional or proprietary protocols may be used as well, and the invention is not limited to these particular identified protocols.

Once network resources have been reserved, and the reservation is to be fulfilled, the data receiver service 32 manages the data transfer between the data source and the data target. As discussed above, the other services modules may be used to resolve replica data location, perform AAA services, and security services associated with this transaction.

An administrative client 34 may be provided to enable an administrative interface to the data management service and/or network resource manager to be used to set values, issue commands, control, and query the underlying services. The administrative client 34 may be used to perform various services on the data transfer scheduling service, such as to query the data management service, debug it, configure it, etc., while it is running. For example, the administrative client may be able to obtain information from the data management service such as the jobs/routes scheduled for a particular client, jobs currently running, current topology model, current parameter list, and many other types of information. Additionally, the administrative client may be used to set values on the data management service, such as internal timeout parameters, the types of statistics the data management service is to generate, etc. The administrative client may also optionally interface the network resource manager.

After completion of a transaction, reserved network resources are released. Optionally, where the network resources have been reserved for a set period of time, the network resources may be released automatically upon expiration of the set period of time.

As discussed above and as shown in FIGS. 2 and 3, in one embodiment of the invention, both the network resource manager and the data management service are provided with the ability to schedule transactions on the network. The scheduling module may be configured in many different ways. According to one embodiment of the invention, a request for a scheduled reservation within a specified window may be answered with a scheduled reservation during that window; a request for a reservation at a precise time can only be answered with a scheduled reservation at that time or failure. One reason for this constraint is that, in one embodiment, a scheduled reservation must fulfill the request and is not able to reserve resources to partially fulfill requests or to fulfill partial requests. Stated another way, in this embodiment a client always receives what it asks for, or nothing. In this embodiment, if the client's request is too constrained to be fulfilled, the client should make a less constrained or different request. In other embodiments a partial fulfillment of a request may be tolerated and the invention is not limited to this embodiment.

A requesting client application can always cancel a scheduled reservation after it has been granted, upon which the system will release the resources and then make them available to be reserved by other applications. In general, requests are loose, or under-constrained. For example, a request may specify that it would be preferred that the transfer occur at a particular time or within a particular time frame, but that the request may be fulfilled at any time within a larger time window. Alternatively, the request may specify that the transfer should occur at the next available time. Additionally, the request may specify additional considerations, such as the cost of the transfer, additional time constraints and preferences, accounting information, and many other aspects associated with the proposed transfer.

The scheduled reservation will result in an allocation at the scheduled time. No further client action is needed to transform a scheduled reservation into an allocation; it happens automatically. If a special “allocation handle” or “resource ticket” is needed, then the client retrieves this from the network management service or data management service via push or pull.

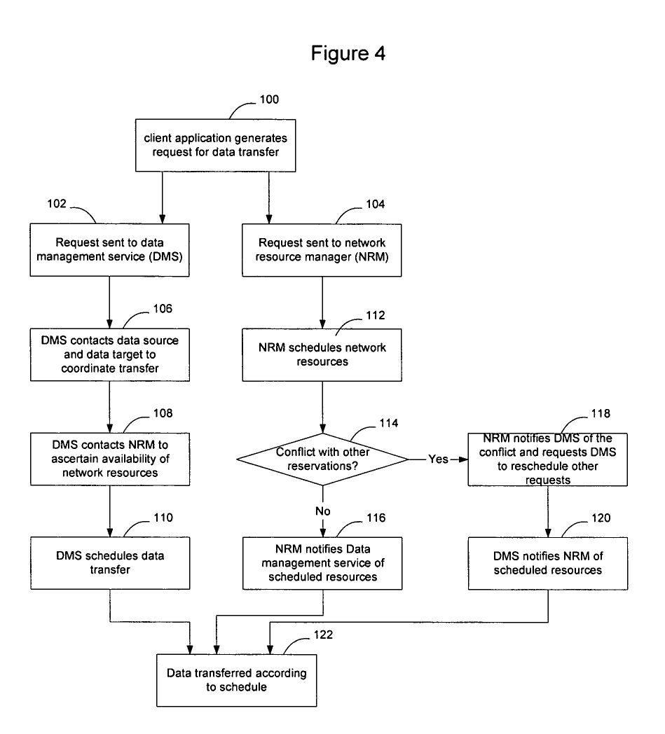

FIG. 4 illustrates a flow chart of an example of a how requests may propagate through the data transfer scheduling service of FIGS. 1-3. As shown in FIG. 4, a client application generates a request for data transfer (100). This request may specify various parameters as discussed above, and will be sent either to the data management service (102) or to the network resources manager (104). If the request is sent to the data management service, the data management service contacts the data source and data target to coordinate the transfer (106). The data management service also contacts the network resource manager to ascertain the availability of network resources (108). Contacting the data management service and network resource manager may occur serially or simultaneously and in any order. Upon receipt of all pertinent constraints, the DMS schedules the transfer (110) taking into account additional constraints imposed by other scheduled requests or requests that are also in the process of being scheduled.

If the request is sent to the network resource manager, the network resource manager ascertains the availability of the network resources and attempts to schedule the request by reserving available network resources (112). The network resource manager also checks to see if the request conflicts with other reservations (114). If there is no conflict, the network resource manager notifies the data management service of the scheduled request (116) so that the data management service has knowledge of the scheduled request and can thus use that knowledge in connection with scheduling other requests. If the request conflicts with other reservations the network resource manager notifies the data management service of the conflict and requests the data management service to reschedule other requests or otherwise optimize scheduling of the request in view of the other contending requests (118). Once the data management service has scheduled/rescheduled requests, it notifies the network resource manager of the new schedule (120).

The responsible scheduling module, either in the data management service or the network resources manager, schedules the data transfer using the constraints in the request, the availability of the network resources, and the availability, or future availability, of the data and/or the capacity to receive the data. In connection with this, the network resource availability may be dependent on other requests. Accordingly, the responsible scheduling module will interrogate its scheduling tables to ascertain if another request can be moved to accommodate this request when the request is not able to be fulfilled on the network resources due to a scheduling conflict. Additionally, once a scheduled transfer has been accepted, it is included in the scheduling table along with any under-constrained parameters so that the scheduled transfer may be rescheduled at a later time if another request is unable to be fulfilled.

At the designated time, the scheduled request is fulfilled under the supervision of the data receiver service, which handles coordination of the scheduled transfer between the data source and the data target (122).

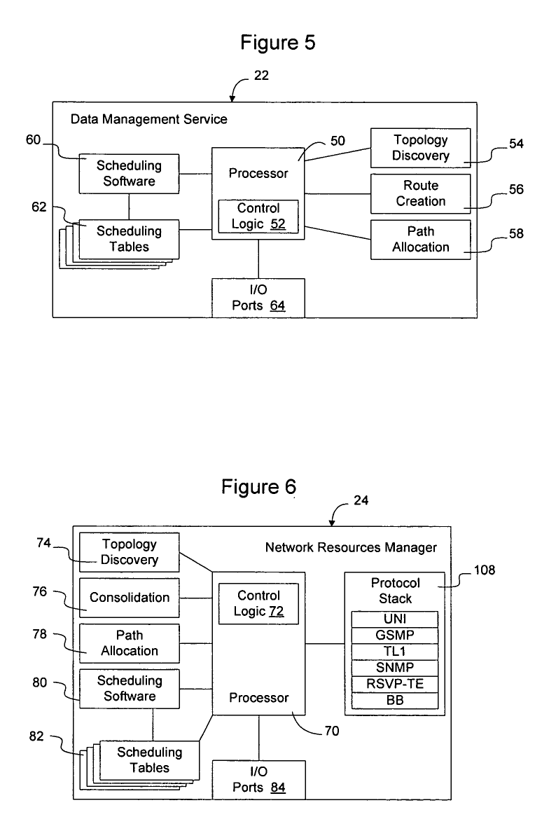

FIGS. 5 and 6 illustrate embodiments of a network element configured to implement the data management service and the network resources manager according to an embodiment of the invention. These network services may be embodied in separate network elements, as illustrated, or may be housed in the same network element.

In the embodiment of the data management service illustrated in FIG. 5, the data management service is configured to be implemented on a network element including a processor 50 having control logic 52 configured to implement the functions ascribed to the data management service discussed herein in connection with FIGS. 1-4. The network element has a native or interfaced memory containing data and instructions to enable the processor to implement the functions ascribed to it herein. For example, the memory may contain software modules configured to perform network topology discovery 54, route creation 56, path allocation 58, and scheduling 60. One or more of these modules, such as the scheduling software module 60, may be provided with access to scheduling tables 62 to enable it to read information from the tables and to take action on the tables, for example to learn of the existence of other scheduled reservations in connection with attempting to fulfill a reservation, and to alter existing reservations in connection with implementing or fulfilling a new reservation. I/O ports 64 are also provided to enable the network element to receive requests, issue instructions regarding fulfilled requests, and otherwise communicate with other constructs in the network.

In the embodiment of the network resources manager illustrated in FIG. 6, the network resources manager is configured to be implemented on a network element including a processor 70 having control logic 72 configured to implement the functions ascribed to the data management service discussed herein in connection with FIGS. 1-4. The network element, in this embodiment, has a native or interfaced memory containing data and instructions to enable the processor to implement the functions ascribed to it herein. For example, the memory may contain software modules configured to perform network topology discovery 74, consolidation 76, path allocation 78, and scheduling 80. One or more of these modules, such as the scheduling software module 80, may be provided with access to scheduling tables 82 to enable it to take other scheduled reservations into account when attempting to fulfill a reservation. I/O ports 84 are also provided to enable the network element to receive requests, issue instructions regarding fulfilled requests, and otherwise communicate with other constructs in the network. A protocol stack may be provided to enable the network resources manager to undertake protocol exchanges with other network elements on the network-to enable it to perform network discovery and management, and to reserve resources on the network.

The control logic 52, 72 may be implemented as a set of program instructions that are stored in a computer readable memory within the network element and executed on a microprocessor, such as processor 50, 70. However, in this embodiment as with the previous embodiments, it will be apparent to a skilled artisan that all logic described herein can be embodied using discrete components, integrated circuitry, programmable logic used in conjunction with a programmable logic device such as a Field Programmable Gate Array (FPGA) or microprocessor, or any other device including any combination thereof. Programmable logic can be fixed temporarily or permanently in a tangible medium such as a read-only memory chip, a computer memory, a disk, or other storage medium. Programmable logic can also be fixed in a computer data signal embodied in a carrier wave, allowing the programmable logic to be transmitted over an interface such as a computer bus or communication network. All such embodiments are intended to fall within the scope of the present invention.

It should be understood that various changes and modifications of the embodiments shown in the drawings and described herein may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

1. A method of scheduling resources on a switched underlay network, the method comprising the steps of:
receiving a request for scheduled resources;
scheduling the request; and
coordinating with a data source to transmit data over the scheduled resources.

2. The method of claim 1, wherein the request has constraints, and wherein coordinating with the data source comprises ascertaining whether the data source is able to transmit data in conformance with the constraints.

3. The method of claim 2, wherein the step of coordinating takes place before the step of scheduling.

4. The method of claim 1, wherein the resources are lambdas.

5. The method of claim 1, wherein the request is an underconstrained request.

6. The method of claim 1, wherein the request is a new underconstrained request, the method further comprising the step of optimizing the utilization of scheduled resources by moving scheduled resources allocated to at least one old request to accommodate the new underconstrained request.

7. The method of claim 6, wherein some of the old requests are underconstrained requests and at least one of the old requests is a constrained request.

8. The method of claim 1, wherein the request is a new underconstrained request, the method further comprising the step of optimizing the utilization of scheduled resources by canceling scheduled resources allocated to at least one old request to accommodate the new underconstrained request.

9. The method of claim 8, further comprising inviting resubmission of the canceled old request.

10. The method of claim 1, further comprising relinquishing scheduled resources where the scheduled resources subsequently are no longer required.

11. The method of claim 1, wherein the request specifies the transfer priority, bandwidth requirements, transfer duration, desired transfer time window, and the time of submission.

12. The method of claim 1, wherein the step of scheduling the request is only performed if the method is able to schedule resources within constraints specified in the request.

13. The method of claim 1, wherein the step of scheduling the request will partially schedule the request if the method is only able to partially schedule resources within the constraints specified in the request.

14. The method of claim 1, wherein the step of scheduling the request enables data transfers to occur on demand, rigidly in the future, loosely in the future, and in a manner constrained by external events.

15. The method of claim 1, further comprising the step of notifying a requesting party of the scheduled resources.

16. The method of claim 1, further comprising the step of interfacing with network resources to reserve bandwidth on the switched underlay network.

17. The method of claim 16, wherein the step of interfacing comprises querying the network for its topology and the relevant characteristics of links to be used to fulfill the request.

18. The method of claim 16, wherein the step of interfacing comprises planning a path through the switched underlay network from a data source to a data target, and reserving bandwidth along the path.

19. The method of claim 16, wherein the request is a request for scheduled resources to enable a large data transfer to take place on the switched underlay network.

20. The method of claim 19, further comprising the step of coordinating large data transfer between a data source and a data target.

21. The method of claim 20, wherein the step of coordinating the large data transfer comprises ascertaining the availability of the data source to transmit the data and the availability of the data target to receive the data.

22. A data transfer scheduling service configured to schedule network resources on a switched underlay network, comprising:
a data management service, said data management service being configured to perform network topology discovery, route creation, and path allocation; and
a network resource manager, said network resource manager being configured to interface network devices in the switched underlay network to schedule network resources on the switched underlay network;
wherein at least one of the data management service and the network resource manager is configured to schedule underconstrained requests for the network resources on the switched underlay network.

23. The data transfer scheduling service of claim 22, wherein at least one of the data management service and the network resource manager is configured to obtain information associated with the availability of a data source and optimize a schedule of scheduled underconstrained requests.
